(19) United States
(12) Patent Application Publication
(10) Pub. No.: US 2018/0001227 A1
(43) Pub. Date: Jan. 4, 2018

(54) NOVEL MULTIMODAL OSCILLATORY CHROMATOGRAPHIC PURIFICATION SYSTEM

(71) Applicant: Michael Dale Hilgert, Fairland, IN (US)

(72) Inventor: Michael Dale Hilgert, Fairland, IN (US)

(21) Appl. No.: 15/200,138

(22) Filed: Jul. 1, 2016

(51) Int. Cl. B01D 15/18; B01D 15/32; B01D 15/34

(52) U.S. Cl. CPC B01D 15/18; B01D 15/34; B01D 15/1814; B01D 15/1864; B01D 15/325

(57) ABSTRACT

The present invention comprises a novel multimodal chromatography sequence of short length alternating adsorption and size exclusion media operating with gradient elution. The novel multimodal chromatography in an oscillating series utilizes the alternating solvent exchange media to reposition the active region of separation back in phase with the target solutes.

Each solvent exchange column bed length in the sequence is designed to achieve a subtle decrease or increase in the solvent gradient (or salt gradient) concentration associated with the two solutes of interest which results in an extension of the active separation or increasing differences in solute velocity for two solutes of interest.

The novel oscillatory chronographic system demonstrates much improved separation capability as shown by a one dimensional model.

### FIELD OF THE INVENTION

The invention described herein is intended for use in preparative purification and analytical separation of large molecules using a novel design for a chromatographic purification system. The invention differs from single modal chromatographic purification by utilizing multimodal chromatography in an oscillating series. FIG. 1 illustrates the typical single column purification strategy. FIG. 2 illustrates a novel oscillatory chromatographic method. The novel strategy is accomplished using multiple short columns or one column with alternating media. The example described herein is for a reverse phase chromatographic separation. This novel concept can be applied to other modes of chromatography. A model is described and presented here for a reverse phase chromatographic separation in a novel alternating reverse phase- solvent exchange media design.

### BACKGROUND

As described by use of standard gradient elution chromatography models (described herein), a single modal chromatography column operating in a gradient elution mode is limited because the solid phase interaction with the target solute occurs within a specific mobile phase concentration range. A small region of the mobile phase gradient contributes to the separation. This active region of solvent concentration is depicted in FIG. 4 for a model system with 2 solutes targeted for separation. FIG. 4 shows a theoretical plot of solvent concentration vs. target solute velocity. The model system is described in herein. Additionally, the theoretical model used to describe the solute movement is explained herein.

FIG. 5 shows a velocity profile for each of two closely related solutes (named Solutel and Solute 2) of interest in a single 30 cm long reverse phase column with gradient elution. The velocity profiles are plotted as solute velocity verse column length. There is minimal difference in the velocity profiles for each solute because they are closely related species. It is observed that the velocity reaches steady state equal to the mobile phase velocity after approximately 15 to 20 cm of bed length and any remaining bed length does not contribute to the separation. The strategy of the novel oscillatory system is to reposition the solvent gradient with respect to the solute positions to move the solutes back into the region of active separation. This is accomplished by using the alternating solvent exchange columns which adjusts the relative position of the small molecule elution gradient profile with respect to the large molecular weight solutes of interest.

### BRIEF SUMMARY OF THE INVENTION

The novel multimodal chromatography in an oscillating series utilizes the alternating solvent exchange media to reposition the active region of separation back in phase with the target solute. The novel oscillatory system is specifically designed to reposition the gradient with respect to the solute positions to move the solutes back into the region of active separation. Each solvent exchange column bed length in the sequence is designed to achieve a subtle decrease in the solvent concentration associated with the two solutes of interest which results in an extension of the active separation.

Note that the gradient elution with the novel system can be operated in one of three modes:
1. A positive slope gradient would be designed to accomplish sequential separations in each sequential reverse phase column. A positive slope gradient would be generally applied to all solutes and would allow discrete increasing separation between all components as the separation proceeds through the column sequence. FIG. 3 depicts the novel chromatography system with a positive gradient slope.
2. A negative sloped gradient would be designed to allow the faster moving component or solute of interest to escape through the column sequence while second solute of interest would be captured by the column sequence and allow an acceleration in the rate of separation between two solutes of interest.
3. An oscillating gradient would be designed to created a resonant frequency with respect to the alternating reverse phase- solvent exchange media design.

### BRIEF DESCRIPTION OF DRAWINGS

FIG. 1: Single Column Chromatographic Purification System

FIG. 2: Novel Oscillatory Chromatographic Purification System

FIG. 3: Novel Chromatographic System with a Positive Gradient Slope Design

FIG. 4: Plot of Solvent Concentration Verses Solute Velocity for a Large Molecule Solute.

FIG. 5: Plot of Solute Velocity And Solvent Concentration Verses Bed Length for a 30 cm Long Column

FIG. 6: Plot of Effluent Mobile Phase Organic Solvent Concentration for

Each Column in a Novel Oscillatory Alternating Positive Gradient Slope Column System

FIG. 7: Plot of Velocity Difference Between Two Large Molecule Solutes Targeted for Separation using Reverse Phase Chromatography Media

FIG. 8: Plot of solute velocity and solvent concentration verses bed length for Media Sections in a Novel Oscillatory Alternating Positive Gradient Slope Column System

FIG. 9: Plot of Effluent Mobile Phase Organic Solvent Concentration for Each Column in a Novel Oscillatory Alternating Column System with a Negative Gradient Slope System

FIG. 10: Plot of Component 1 and Component 2 Retention Time for Each Sequential Column in a Novel Oscillatory Alternating Column System with a Negative Gradient Slope System

FIG. 11: Plot of solute velocity and solvent concentration verses bed length rev phase columns in a Novel Oscillatory Alternating Column System with a Negative Gradient Slope System

FIG. 12: Theoretical Elution Gradient for Reverse Phase Chromatography Column generated by Equation 2 g

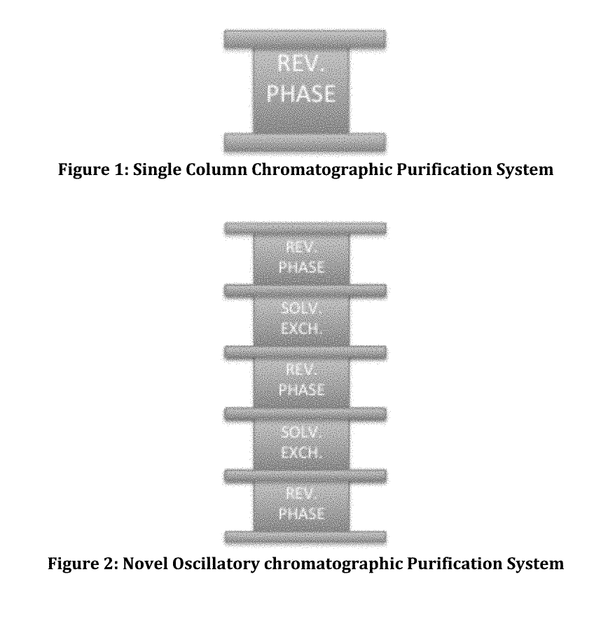

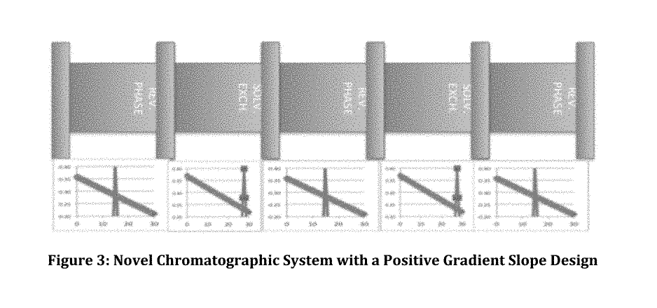

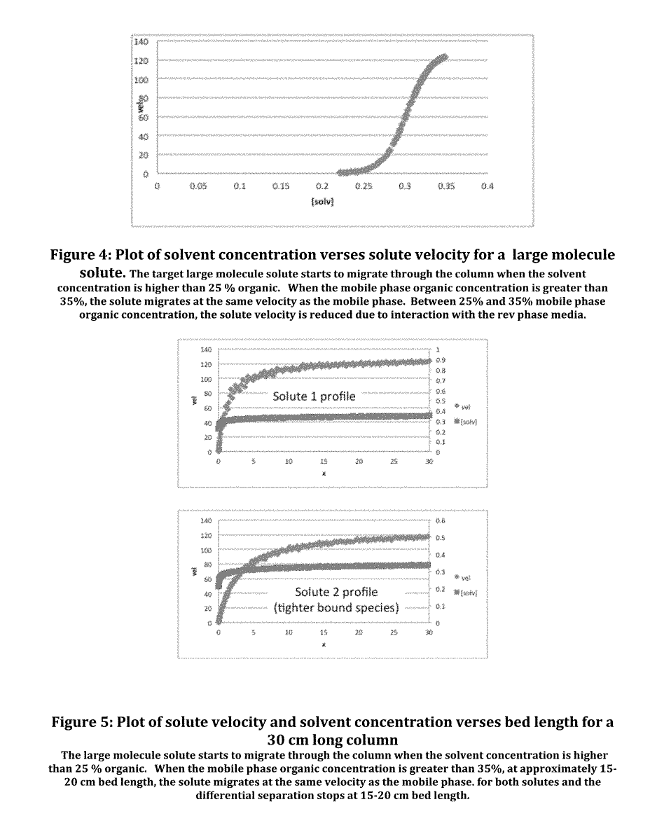

### DETAILED DESCRIPTION OF THE INVENTION

Theoretical modeling is used herein to demonstrate an improved separation using the novel multimodal oscillatory chromatographic purification system. A one-dimensional model is used to describe a challenging separation between two closely related peptides. A reverse phase system is chosen for the detailed description of the invention. This invention extends to any adsorption system.

The Solute velocity dependence on organic solvent concentration in gradient elution with reverse phase chromatography is described by the following standard chromatography solute movement and reverse phase gradient equations:

$${k}_{a}^{′} = \frac{{t}_{a} - {t}_{0}}{{t}_{0}} \qquad Equation 2 a$$

k′ₐ=retention factor for solute of interest (solute a)
tₐ=retention time for solute of interest (solute a)
t₀=retention time for unretained solute
Revise Equation 2a for small column slice

Δtₐ=Δt₀(k′ₐ+1) Equation 2b
Δtₐ=retention time for solute of interest across small section of column
Δt₀=retention time for unretained solute across small section of column

log k′ₐ=Sφ+c Equation 2c

k′ₐ=10^{(sφ+c)} Equation 2d
S=emperical slope=−29.898 for component 1/solute 1 (product)=−29.124 for component 2/solute 2 (impurity) for example scenario
ø=fractional solvent concentration
c=constant=log k₀=9.034 for component 1/solute 1 (product)=8.98 for component 2/solute 2 (impurity) for example scenario

Utilizing Equation 2b in velocity expression:

$${v}_{a} = \frac{Δ x}{Δ {t}_{a}} = \frac{Δ x}{Δ {t}_{0} ( {k}_{a}^{′} + 1 )} = \frac{v}{{∈}_{Trpc} ( {k}_{a}^{′} + 1 )} \qquad Equation 2 e$$

vₐ=solute “a” velocity
Δx=small slice of column (small column length or distance)
v=mobile phase superficial velocity in

$$\frac{cm}{hr} ( flowrate \div column cross sectional A ) = 100 cm \text{/} hr$$

for example scenario
∈_{Trpc}=rev. phase column total void fraction=0.78 for example scenario

Combining Equation 2e and 2d provides an expression for solute “a” velocity:

$$\begin{matrix}{v}_{a} = \frac{v}{{∈}_{T} [ {10}^{( S φ + c )} + 1 ]} = \frac{[ \frac{v}{{∈}_{Trpc}} ]}{[ {10}^{( S φ + c )} + 1 ]}\end{matrix} \qquad Equation 2 f$$

The organic solvent gradient concentration dependence on time and column axial distance in rev phase chromatography is described by the following equation (Equation 2g). Equation 2g is a linear expression for 2-dimensional (time and column axial distance) linear elution gradient.

$$∅ = {a}_{0} + {\frac{v}{60 {∈}_{Trpc}} [ \frac{Δ a}{Δ x} ]}_{RPC} t + {[ \frac{Δ a}{Δ x} ]}_{RPC} x \qquad Equation 2 g$$

ø=fractional solvent concentration
a₀=initial solvent concentration at t=0 and x=0 (or from previous SEC column)
x=axial distance down the column length (cm)
t=time (mins)
v=mobile phase superficial velocity in cm/hr (flowrate÷column cross sectional A)
∈_{Trpc}=column total void fraction

$${[ \frac{Δ a}{Δ x} ]}_{RPC} = rev . phase column solvent gradient slope$$

(change in organic solvent conc. per cm of column axial distance)

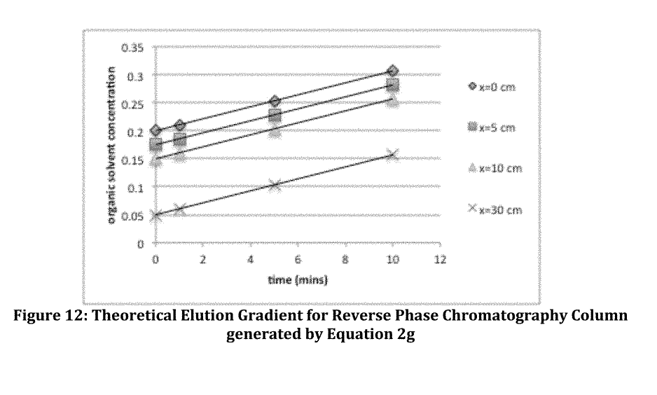

FIG. 12 shows a plot of the linear elution gradient described by Equation 2e with aₒ=0.20.

The expression for elution time, Equation 2j, in a size exclusion (SEC) column is developed from the fundamental expression describing solute movement in SEC columns, equation 2h.

$$\begin{matrix}t = {t}_{0} + {K}_{sec} ( {t}_{t} - {t}_{0} ) & Equation 2 h \\ t = 60 ( \frac{z {∈}_{void}}{v} + {K}_{sec} [ \frac{z}{v} - \frac{z {∈}_{void}}{v} ] ) & Equation 2 j\end{matrix}$$

t=time (mins)
t₀=retention time for totaly excluded species (mins)
tₜ=retention time for mobile phase (mins)
v=mobile phase superficial velocity in

$$\frac{cm}{hr} ( flowrate \div column cross sectional A )$$

E_{void}=column solid phase void fraction=0.35 for example scenario
K_{sec}=void fraction of the solid phase in which the large solutes of interest can access
K_{sec}=0.0 for example scenario
(K_{sec} can be optimized to exclude the larger size solute of interest)
z=column length

The linear Expression for 2-dimensional (time and column axial distance) linear elution gradient used for the reverse phase column applies to the SEC column. The total void fraction will have a different value because SEC media typically are designed with a large void fraction compared to adsorptive media.

$$∅ = {a}_{0} + {\frac{v}{60 {∈}_{Tsec}} [ \frac{Δ a}{Δ x} ]}_{SEC} t + {[ \frac{Δ a}{Δ x} ]}_{SEC} x \qquad Equation 2 g$$

ø=fractional solvent concentration
a₀=initial solvent concentration from previous RPC column
x=axial distance down the column length (cm)
t=time (mins)
v=mobile phase superficial velocity in

$$\frac{cm}{hr} ( flowrate \div column cross sectional A )$$

E_{Tsec}=column total void fraction=0.95 for example scenario

$${[ \frac{Δ a}{Δ x} ]}_{SEC} = S E C column solvent gradient slope$$

(change in organic solvent conc. per cm of column axial distance)

Note that the gradient slope (in units of change in organic solvent concentration per cm of axial distance) for the size exclusion column will be different than for the reverse phase column because the total void fraction for the size exclusion column is different than the total void fraction for the reverse phase column. The gradient slope for the size exclusion column can be determined from the reverse phase column slope using the void fraction ratio for each column per equation 2k:

$${[ \frac{Δ a}{Δ x} ]}_{SEC} = {[ \frac{{∈}_{Trpc}}{{∈}_{Tsec}} ] [ \frac{Δ a}{Δ x} ]}_{RPC} \qquad Equation 2 k$$

A numerical computational method is used to determine the elution time of each solute of interest. Equations 2g, 2f, and 2j are used in computations to describe separation of two closely related large molecule species. Each column is numerically integrated with the output conditions used as initial conditions for the subsequent column sequence.

One operating mode of the Novel Oscillatory Chromatographic Purification System with a Positive Gradient Slope is illustrated herein by utilizing the one dimensional model per the previous description utilizing equations 2g, 2f and 2j.

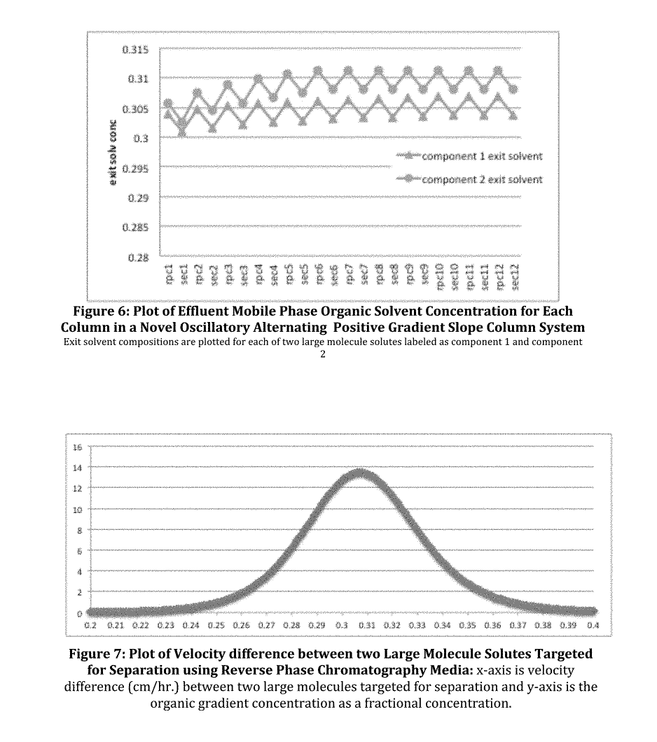

The novel multimodal chromatography in an oscillating series utilizes the alternating solvent exchange media to reposition the solvent gradient active region of separation back in phase with the target solute as shown in FIG. 6. FIG. 6 shows solvent concentration in contact with each of the two large molecules of interest at the exit of each alternating media section. The 12 sections of reverse phase media followed by size exclusion media produces a saw blade affect as the solvent concentration associated with each of two large molecules in the separation process decreases after each size exclusion media section. The novel oscillatory system is specifically designed to reposition the gradient with respect to the solute positions to move the solutes back into the region of active separation. Each solvent exchange column bed length in the sequence is designed to achieve a subtle decrease in the solvent concentration associated with the two solutes of interest which results in an extension of the active separation. An SEC column length of 6 cm for the first size exclusion column (labeled as “sec 1” in FIG. 6) shifts the relative position of the organic solvent gradient concentration with respect to the solutes of interest down by approximately 0.4% organic solvent concentration out of the 1st reverse phase column prior to the 2^{nd} reverse phase column. The remaining 11 solvent exchange columns used in the scenario to generate FIG. 6 continue to reposition the gradient concentration with respect to the solutes of interest after each reversed phase column in order to achieve continued separation of the solutes of interest. The series of alternating columns reaches a pseudo-steady-state oscillation of solvent concentration if the column lengths and gradient slope are set to the conditions described by Table 1.

Table 1 provides the Novel Oscillatory Alternating Column design parameters and theoretical results for the specific model system used in the scenario to generate FIG. 6. The novel system improves the separation performance of the standard one column reverse phase system. The novel system using an oscillatory sequence of twelve column pairs increases the separation time from 0.8 minutes with a single media section to 2.54 minutes with the 12 media pairs.

Design parameters for the Novel Oscillatory Alternating Column system include gradient slope, bed depth of each adsorptive (rev. ph.) column, bed depth of each solvent exchange column, and gradient start concentration and are listed in

TABLE 1
Novel Oscillatory Column Design Configuration
and Theoretical 1-Dimensional Performance with Positive
Gradient Slope

| | | | | | | | grad slope | 0.001 |
|---|---|---|---|---|---|---|---|---|
| | | | | | | | grad start | 0.3 |
| | component 1 | | | component 2 | | | | retention |
| | Ret. | sum rpc | | Ret. | | | | time diff. |
| | Time | time | exit | Time | sum rpc | exit | Z | btwn |
| | (mins) | (mins) | solvent | (mins) | time (mins) | solvent | (cm) | solutes |
| rpc1 | 3.75 | 3.75 | 0.3040 | 4.55 | 4.55 | 0.3057 | 4 | 0.80 |
| sec1 | 1.26 | 5.01 | 0.3009 | 1.26 | 5.81 | 0.3026 | 6 | 0.00 |
| rpc2 | 3.64 | 8.65 | 0.3047 | 4.18 | 9.99 | 0.3075 | 4 | 0.54 |
| sec2 | 1.26 | 9.91 | 0.3016 | 1.26 | 11.25 | 0.3044 | 6 | 0.00 |
| rpc3 | 3.58 | 13.49 | 0.3052 | 3.96 | 15.21 | 0.3089 | 4 | 0.38 |
| sec3 | 1.26 | 14.75 | 0.3021 | 1.26 | 16.47 | 0.3058 | 6 | 0.00 |
| rpc4 | 3.52 | 18.27 | 0.3056 | 3.80 | 20.27 | 0.3099 | 4 | 0.28 |
| sec4 | 1.26 | 19.53 | 0.3025 | 1.26 | 21.53 | 0.3068 | 6 | 0.00 |
| rpc5 | 3.48 | 23.01 | 0.3060 | 3.68 | 25.21 | 0.3107 | 4 | 0.20 |
| sec5 | 1.26 | 24.27 | 0.3028 | 1.26 | 26.47 | 0.3075 | 6 | 0.00 |
| rpc6 | 3.44 | 27.71 | 0.3062 | 3.60 | 30.07 | 0.3112 | 4 | 0.16 |
| sec6 | 1.26 | 28.97 | 0.3031 | 1.26 | 31.33 | 0.3081 | 6 | 0.00 |
| rpc7 | 3.42 | 32.39 | 0.3064 | 3.60 | 34.93 | 0.3112 | 4 | 0.18 |
| sec7 | 1.26 | 33.65 | 0.3033 | 1.26 | 36.19 | 0.3081 | 6 | 0.00 |
| rpc8 | 3.40 | 37.05 | 0.3065 | 3.60 | 39.79 | 0.3112 | 4 | 0.20 |
| sec8 | 1.26 | 38.31 | 0.3034 | 1.26 | 41.05 | 0.3081 | 6 | 0.00 |
| rpc9 | 3.40 | 41.71 | 0.3067 | 3.60 | 44.65 | 0.3112 | 4 | 0.20 |
| sec9 | 1.26 | 42.97 | 0.3036 | 1.26 | 45.91 | 0.3081 | 6 | 0.00 |
| rpc10 | 3.38 | 46.35 | 0.3068 | 3.60 | 49.51 | 0.3112 | 4 | 0.22 |
| sec10 | 1.26 | 47.61 | 0.3037 | 1.26 | 50.77 | 0.3081 | 6 | 0.00 |
| rpc11 | 3.36 | 50.97 | 0.3069 | 3.60 | 54.37 | 0.3112 | 4 | 0.24 |
| sec11 | 1.26 | 52.23 | 0.3038 | 1.26 | 55.63 | 0.3081 | 6 | 0.00 |
| rpc12 | 3.36 | 55.59 | 0.3069 | 3.60 | 59.23 | 0.3112 | 4 | 0.24 |
| sec12 | 1.26 | 56.85 | 0.3038 | 1.26 | 60.49 | 0.3081 | 6 | 0.00 |

The novel alternating column system can be designed for any number of column pairs. This example utilizes 12 media section pairs or 12 column pairs. The media section pairs will be referred to as column pairs with the caveat that the novel alternating media hardware may be designed as media sections in a single column, or separate columns for each media. The column lengths or media section lengths are identical in each pair, thus allowing a looped configuration where the feed solution is injected into the system and recycled through a loop configuration that could be recycled 12 times through a single column pair, or 6 times through a double column pair (2 RPC and 2 SEC columns) to achieve the same results as a once-through 12 column pair system.

Note in the Table 1 list of parameters, the starting organic solvent concentration of the gradient is 0.30 or 30%. This is the organic solvent concentration that provides the largest difference in the large molecule solute velocities of the two solutes of interest in the separation scheme. A plot of the velocity difference in solute of interest 1 and 2 verses organic solvent concentration in the RPC media is shown in FIG. 7. The velocity difference is greatest at an organic concentration of 30%. That is rationale for choosing the initial condition so that the system operates close to the maximum velocity difference or maximum separation potential at the 30% organic solvent concentration.

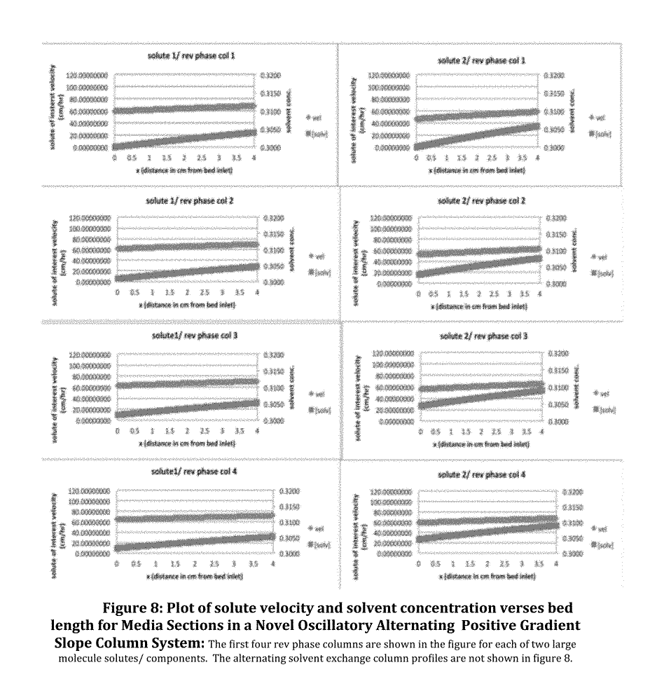

FIG. 8 shows the velocity profile for each of two closely related solutes (named Solute 1 and Solute 2) of interest in each of four initial sequential reverse phase columns with gradient elution. The last 8 reverse phase columns associated with the scenario depicted in FIG. 6 and Table 1 are not included in FIG. 8 because the system approaches steady-state after the 4^{th} column pair, therefore subsequent reverse phase column profiles would look similar to the 4^{th} column profile. The velocity profiles are plotted as solute velocity verse column length. Plots for the solvent exchange columns between each of the sequential reverse phase columns are not included in FIG. 7. The strategy of the novel oscillatory system is to reposition the gradient position with respect to the large molecule solute positions so as to keep the large molecule solutes in the region of the most active separation.

In the example presented here, the cycle of sequential columns does not extend beyond 12 cycles. If the sequence of columns is established as a repeatable configuration, the system could be design as a loop with an injection port and the system could be recycled until the desired separation is achieved.

A second operating mode of the Novel Oscillatory Chromatographic Purification System with a Negative Gradient Slope is illustrated herein by again utilizing the one dimensional model per the previous description utilizing equations 2g, 2f and 2j.

Alternatively to the positive gradient slope design, the novel oscillatory chromatography configuration can be designed to accommodate a negative slope gradient. The negative gradient slope design produces an acceleration in the differential migration rate of the two solutes of interest.

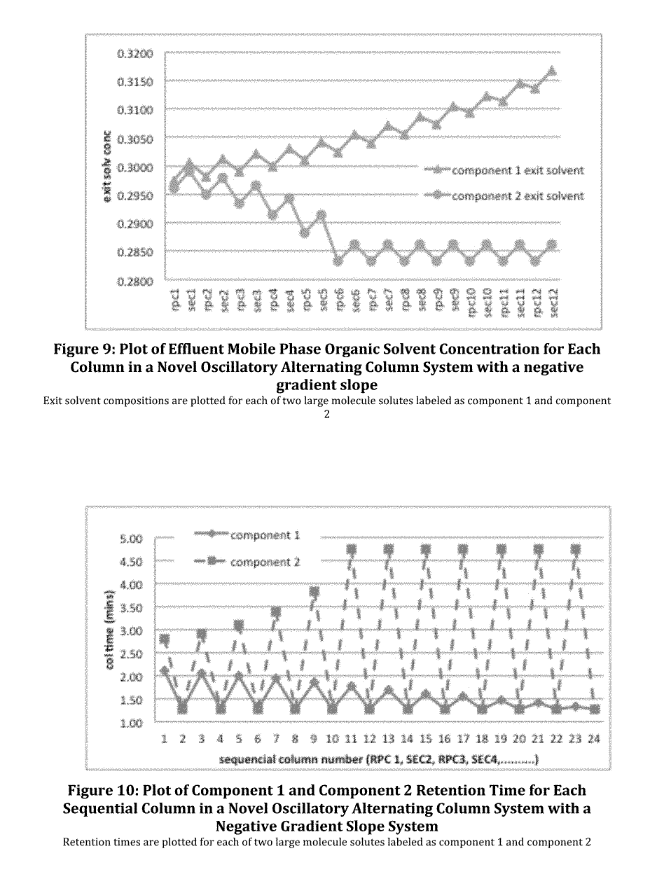

The novel multimodal chromatography in an oscillating series utilizes the alternating solvent exchange media to reposition the active region of separation back in phase with the faster moving solute of interest, component 1, while the slower moving solute of interest, component 2, is exposed to a decreasing organic solvent concentration as shown in FIG. 9. The novel oscillatory system is specifically designed to reposition the gradient with respect to the solute positions to produce an increasing difference in the retention time between the two solutes of interest as shown in FIG. 10. Each solvent exchange column bed length in the sequence is designed to achieve a subtle increase in the solvent concentration for component 1 and a continual decrease in the solvent concentration associated with component 2 which results in an acceleration of the active separation.

An SEC column length for the first size exclusion column (labeled sec 1 in FIG. 9) of 6 cm shifts the relative position of the organic solvent gradient concentration with respect to the component 1 and component 2 in opposite directions which results in substantial enhancement of the separation between the two components or solutes of interest.. The remaining 11 solvent exchange columns used in the scenario to generate FIG. 6 continue to reposition the gradient concentration with respect to the solutes of interest after each reversed phase column in order to achieve continued separation of the solutes of interest as shown in FIG. 10.

FIG. 10 provides a plot of retention time in each column (including both SEC and RPC columns). Note that a difference in retention time between the two components or solutes of interest occur only in the reverse phase columns. The alternating SEC columns have the same retention time for both components.

The series of alternating columns produces an ever increasing difference in solvent concentration associated with each component or solute of interest if the column lengths and gradient slope are set to the conditions described by Table 2.

Table 2 provides the Novel Oscillatory Alternating Column design parameters and theoretical results for the specific model system used in the scenario to generate FIGS. 9 and 10. The novel system improves the separation performance of the standard one column reverse phase system. The difference in retention time between the two components (solutes of interest) for each column is shown in table 2. The sum of the differences in retention time or the cumulative difference in retention times for the two components is 12.07 minutes. The novel system using an oscillatory sequence of twelve column pairs increases the separation time from 0.69 minutes with a single column to 12.07 minutes with the 12 column pair.

Design parameters for the Novel Oscillatory Alternating Column system include gradient slope, bed depth of each adsorptive (rev. ph.) column, bed depth of each solvent exchange column, and gradient start concentration and are listed in Table 2.

TABLE 2
Novel Oscillatory Column Design
Configuration and Theoretical 1-Dimensional
Performance with Negative Gradient Slope

| | | | | | | | grad slope | −0.001 |
|---|---|---|---|---|---|---|---|---|
| | | | | | | | grad start | 0.3 |
| | component 1 | | | component 2 | | | | retention |
| | Ret. | sum rpc | | Ret. | sum rpc | | | time diff. |
| | Time | time | exit | Time | time | exit | Z | btwn |
| | (mins) | (mins) | solvent | (mins) | (mins) | solvent | (cm) | solutes |
| rpc1 | 2.11 | 2.11 | 0.2975 | 2.80 | 2.80 | 0.2960 | 2 | 0.69 |
| sec1 | 1.26 | 3.37 | 0.3006 | 1.26 | 4.06 | 0.2991 | 6 | 0.00 |
| rpc2 | 2.06 | 5.43 | 0.2982 | 2.92 | 6.98 | 0.2949 | 2 | 0.86 |
| sec2 | 1.26 | 6.69 | 0.3013 | 1.26 | 8.24 | 0.2980 | 6 | 0.00 |
| rpc3 | 2 | 8.69 | 0.2990 | 3.10 | 11.34 | 0.2934 | 2 | 1.10 |
| sec3 | 1.26 | 9.95 | 0.3022 | 1.26 | 12.60 | 0.2965 | 6 | 0.00 |
| rpc4 | 1.94 | 11.89 | 0.3000 | 3.38 | 15.98 | 0.2913 | 2 | 1.44 |
| sec4 | 1.26 | 13.15 | 0.3031 | 1.26 | 17.24 | 0.2944 | 6 | 0.00 |
| rpc5 | 1.86 | 15.01 | 0.3011 | 3.84 | 21.08 | 0.2882 | 2 | 1.98 |
| sec5 | 1.26 | 16.27 | 0.3043 | 1.26 | 22.34 | 0.2913 | 6 | 0.00 |
| rpc6 | 1.78 | 18.05 | 0.3024 | 4.74 | 27.08 | 0.2832 | 2 | 2.96 |
| sec6 | 1.26 | 19.31 | 0.3056 | 1.26 | 28.34 | 0.2863 | 6 | 0.00 |
| rpc7 | 1.70 | 21.01 | 0.3039 | 4.74 | 33.08 | 0.2832 | 2 | 3.04 |
| sec7 | 1.26 | 22.27 | 0.3070 | 1.26 | 34.34 | 0.2863 | 6 | 0.00 |
| rpc8 | 1.62 | 23.89 | 0.3056 | 4.74 | 39.08 | 0.2832 | 2 | 3.12 |
| sec8 | 1.26 | 25.15 | 0.3087 | 1.26 | 40.34 | 0.2863 | 6 | 0.00 |
| rpc9 | 1.56 | 26.71 | 0.3074 | 4.74 | 45.08 | 0.2832 | 2 | 3.18 |
| sec9 | 1.26 | 27.97 | 0.3105 | 1.26 | 46.34 | 0.2863 | 6 | 0.00 |
| rpc10 | 1.48 | 29.45 | 0.3093 | 4.74 | 51.08 | 0.2832 | 2 | 3.26 |
| sec10 | 1.26 | 30.71 | 0.3124 | 1.26 | 52.34 | 0.2863 | 6 | 0.00 |
| rpc11 | 1.40 | 32.11 | 0.3114 | 4.74 | 57.08 | 0.2832 | 2 | 3.34 |
| sec11 | 1.26 | 33.37 | 0.3145 | 1.26 | 58.34 | 0.2863 | 6 | 0.00 |
| rpc12 | 1.34 | 34.71 | 0.3137 | 4.74 | 63.08 | 0.2832 | 2 | 3.40 |
| sec12 | 1.26 | 35.97 | 0.3168 | 1.26 | 64.34 | 0.2863 | 6 | 0.00 |

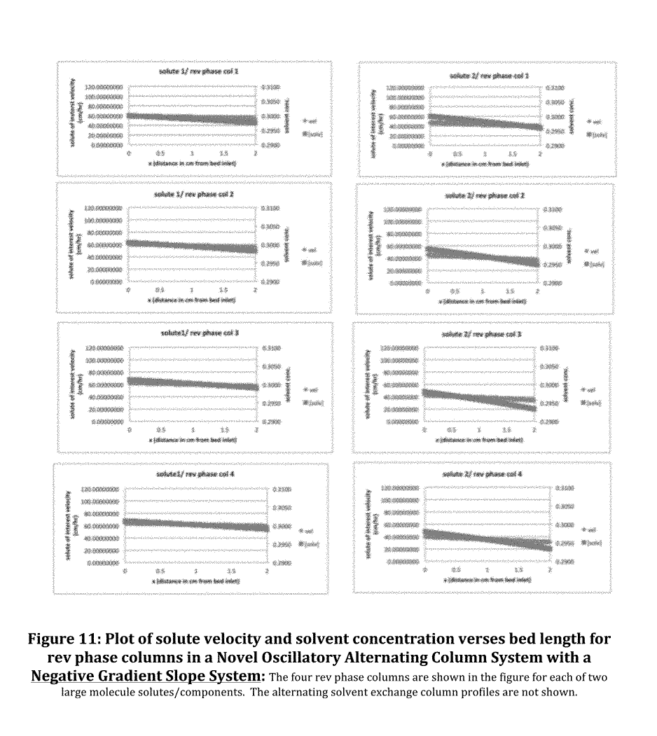

FIG. 11 shows the velocity profile for each of two closely related components or solutes (named Solutel and Solute 2) of interest in each of four initial sequential reverse phase columns with gradient elution. The last 8 reverse phase columns associated with the scenario depicted in FIG. 9, FIG. 10, and Table 1 are not included in FIG. 11. The system does not approach steady state, but continues to increase in separation time between the two solutes or components of interest. The velocity profiles are plotted as solute velocity verse column length. Plots for the solvent exchange columns between each of the sequential reverse phase columns are not included in FIG. 11. The strategy of the novel oscillatory system is to reposition the gradient position with respect to the solute positions so as to keep the solutes in the region of the most active separation.

In the example presented here, the cycle of sequential columns does not extend beyond 12 cycles. If the sequence of columns is established as a repeatable configuration, the system could be design as a loop with an injection port and the system could be recycled until the desired separation is achieved.

1. A novel chromatography purification strategy for large molecules can be accomplished using multimodal alternating adsorption and size exclusion media in an oscillatory chromatographic method with gradient elution. The novel oscillatory system greatly enhances the separation of two large molecule species as demonstrated by 1-dimensional modeling.

2. The novel strategy is accomplished using multiple short columns or one column with alternating media. The configuration can be recycled or looped to achieve the desired separation.

3. The elution gradient slope may be positive or negative or oscillatory.

4. The invention applies to both preparative and analytical scales of operation.
